(19) United States
(12) Patent Application Publication
(10) Pub. No.: US 2025/0342062 A1
(43) Pub. Date: Nov. 6, 2025

(54) METHODS AND APPARATUS TO AUTOSCALE COMPUTE INSTANCES IN GROUPS BASED ON WORKLOAD

(71) Applicant: Cloudera, Inc., Santa Clara, CA (US)

(72) Inventors: Andrew Paul Sherman, San Francisco, CA (US); Abhishek Rawat, San Jose, CA (US); Vincent Kulandaisamy, Lakeway, TX (US); Kurt Wilhelm Deschler, Sudbury, MA (US)

(21) Appl. No.: 18/654,984

(22) Filed: May 3, 2024

(51) Int. Cl. G06F 9/50

(52) U.S. Cl. CPC G06F 9/5038; G06F 9/5072; G06F 2209/501; G06F 2209/5011; G06F 2209/5019; G06F 2209/505

(57) ABSTRACT

Disclosed examples select a first quantity of executors for a first executor group in the virtual compute cluster; select a second quantity of executors for a second executor group in the virtual compute cluster, the first quantity of executors different from the second quantity of executors; in response to a first task, instantiate the first executor group in the virtual compute cluster based on the first quantity of executors satisfying a first resource demand of the first task; and in response to a second task, instantiate the second executor group in the virtual compute cluster based on the second quantity of executors satisfying a second resource demand of the second task.

### FIELD OF THE DISCLOSURE

This disclosure relates generally to computing platforms and, more particularly, to methods and apparatus to autoscale compute instances in groups based on workload.

### BACKGROUND

A network environment may be used to connect users to distributed computer resources such as CPU, memory, and storage. Such distributed resources can be used to process workloads corresponding to user requests. The distributed resources can be implemented in a cloud computing environment so that the resources can be allocated when needed to process a particular workload and then de-allocated and/or re-assigned to another task request once the current task has been processed.

### BRIEF DESCRIPTION OF THE DRAWINGS

FIG. 1 is a block diagram of an example virtual compute cluster (VCC) environment in which an example workload-aware autoscaler operates to autoscale executor groups based on different conditions.

FIG. 2 is an example dynamic executor group size VCC environment in which the workload-aware autoscaler of FIG. 1 can scale up or scale down executor group sizes based on different conditions.

FIGS. 3A and 3B show the example dynamic executor group size VCC environment of FIG. 2 in which executor group sizes are scaled up and scaled down based on different conditions.

FIG. 4 is an example static executor group size VCC environment in which the workload-aware autoscaler of FIG. 1 can scale up or scale down executor group quantities based on different conditions.

FIGS. 5A and 5B show the example static executor group size VCC environment of FIG. 4 in which executor group quantities are scaled up based on resource demands.

FIG. 5C shows scaling down of resources in the example static executor group size VCC environment of FIG. 4 based on resource capacity and system load.

FIG. 5D shows promotion of tasks between executor groups in the example static executor group size VCC environment of FIG. 4 based on service level agreements.

FIG. 6 is a flowchart representative of example machine-readable instructions and/or example operations that may be executed, instantiated, and/or performed by example programmable circuitry to implement the workload-aware autoscaler of FIG. 1.

FIG. 7 is another flowchart representative of example machine-readable instructions and/or example operations that may be executed, instantiated, and/or performed by example programmable circuitry to implement the workload-aware autoscaler of FIG. 1.

FIG. 8 is a flowchart representative of example machine-readable instructions and/or example operations that may be executed, instantiated, and/or performed by example programmable circuitry to implement the workload-aware autoscaler of FIG. 1 to select a quantity of executors for an executor group based on cost.

FIG. 9 is a flowchart representative of example machine-readable instructions and/or example operations that may be executed, instantiated, and/or performed by example programmable circuitry to implement the workload-aware autoscaler of FIG. 1 to allocate a task and scale down an executor group upon task completion.

FIG. 10 is a flowchart representative of example machine-readable instructions and/or example operations that may be executed, instantiated, and/or performed by example programmable circuitry to implement the workload-aware autoscaler of FIG. 1 to scale up and scale down executor groups based on one or more conditions.

FIG. 11 is a block diagram of an example processing platform including programmable circuitry structured to execute, instantiate, and/or perform the example machine-readable instructions and/or perform the example operations of FIGS. 6-10 to implement the WAA 102 of FIG. 1.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine-readable instructions of FIGS. 6-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Distributed database systems can run tasks (e.g., analytic structured query language (SQL) queries or any other types of tasks) using resources (e.g., central processing unit (CPU) resources, memory resources, storage resources, IO resources, etc.) of many computers. A cloud data warehouse is a containerized distributed database system that operates on cloud computing resources, either externally hosted in a public cloud or internally hosted in a private cloud. In examples disclosed herein, a container is a self-contained unit of software that includes the programming code and code dependencies (e.g., runtime, system tools, system libraries, settings, etc.) to create an isolated runtime environment in a computing resource. Using a container allows a containerized application to run in the isolated runtime environment in a manner that is isolated and independent from other, external environments. Similarly, a containerized system is a system that runs in a self-contained environment that is isolated and independent from other systems. An Executor Group (EG) is a group of compute nodes that have been assembled for the purpose of collectively processing sets of data. Users can run a workload on the cloud data warehouse where individual tasks in the workload may have different resource requirements such that it is inefficient to run every task in the same-sized executor group. Autoscaling allows the cloud data warehouse to change size dynamically by adding and subtracting EGs as workload size varies to maximize machine utilization.

Prior alternatives to autoscaling are to create an EG that is large enough to run all tasks of a workload, or to create multiple Virtual Compute Clusters (VCCs) and force users to explicitly direct their tasks to the multiple VCCs. Both approaches typically result in low machine utilization. In addition, running differently sized tasks on the same group of executors can cause noisy neighbor problems in which smaller tasks are starved for resources when larger tasks are running and, accordingly, the smaller tasks execute slower than is acceptable.

Unlike prior solutions, examples disclosed herein allow tasks of one or more workloads to be scheduled to run on differently sized EGs, each of which can be scaled up and scaled down independently in units of EG size to facilitate concurrent query execution. As used herein, a task is a unit of work (e.g., a query, an operation, etc.) that is allocatable for processing by an EG. As used herein, a workload includes one or more tasks. In examples disclosed herein, workloads and tasks are used interchangeably. For example, multiple tasks running together can be referred to as a workload. Additionally, the tasks could be split and grouped into different workloads like small, medium, and large, or some other classification, and the split-up and re-grouped tasks could still collectively be referred to as a workload. As used herein, an EG is a cluster of executors that can process one or more tasks. In examples disclosed herein, an EG includes a number of executors and may be implemented on a compute node. As used herein, an EG size (also referred to as a cluster size) refers to the quantity of executors in an EG. As such, the number of executors (e.g., resource capacity) defines the size of an EG. The size of an EG determines the size of a workload that can be processed by the EG. A larger-size EG has a larger resource capacity than a smaller-size EG. As used herein, an executor is a compute resource (e.g., a compute instance of hardware circuitry (e.g., a compute node), a virtual machine, a containerized application (e.g., a Kubernetes® containerized pod or unit of compute), software, etc.) allocatable to an EG to process a task or a portion of a task.

In some examples, EG sizes are dynamic such that the quantity of executors in an EG can change based on the resource demand of a task. As such, a resource capacity of a dynamically resizable EG can be scaled up or scaled down based on one or more conditions associated with task execution. In other examples, EG sizes are static such that the quantities of executors in EGs do not change. With static sizing, the workload is understood in advance and a VCC is configured to have sufficient EG resources to execute the workload. A configuration may include EG size, minimum number of EGs, maximum number of EGs, etc. to accommodate, for example, a minimum expected load, an intermediate expected load, and a peak expected load. With dynamic sizing, the workload could change over a period of time and so the VCC adapts to the changing workloads and determines the ideal EG size dynamically. In such examples, teachings of this disclosure can scale up or scale down resource capacity by instantiating an entire EG or shutting down and releasing an entire EG based on one or more conditions associated with task execution.

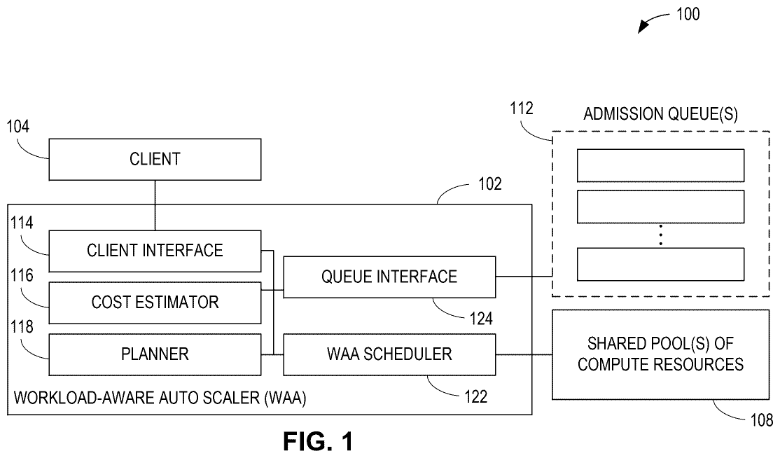

FIG. 1 is a block diagram of an example virtual compute cluster (VCC) environment 100 in which an example workload-aware autoscaler (WAA) 102 operates to autoscale EGs based on different conditions. In examples disclosed herein, autoscaling enables both scaling up and scaling down of EGs to meet changing needs of task execution, to save costs on resources when they are not needed, and to efficiently utilize resources. For example, in a private cloud (e.g., a cloud system hosted on site in a local network) or in an on-premise setup (e.g., a non-cloud compute cluster), if multiple VCCs are competing for resources, examples disclosed herein could be used to scale down one VCC's EGs so that another VCC's requests are not starved and can be processed. As used herein, a workload includes one or more tasks to be processed by one or more executors. The VCC environment 100 also includes an example client device 104 in communication with the WAA 102. The client device 104 submits task processing requests to the WAA 102. Although only the single client device 104 is shown, the WAA 102 may receive concurrent task processing requests from any number of client devices.

The VCC environment 100 is instantiated in a database warehouse (e.g., a Cloudera® database warehouse (CDW)). In examples disclosed herein, a VCC is an instance of compute resources to execute tasks. In some examples, a VCC runs on pods and containers (e.g., in Elastic Kubernetes Service (EKS), Azure Kubernetes Service (AKS), Google Kubernetes Engine (GKE), OpenShift Container Platform (OCP), Rancher Kubernetes Engine (RKE) or other such Kubernetes® deployed clusters), virtual machines (e.g., in Amazon Web Services (AWS), Microsoft Azure Cloud Services, Google Cloud Platform (GCP) and other such cloud provider's data centers or private data centers), or on-premises compute clusters. Using a VCC, such as the VCC environment 100, a cloud customer can access tables and views of its data in, for example, a data lake of a database catalog. The VCC environment 100 can bind compute resources and storage resources by executing tasks on tables and views.

Examples disclosed herein may be implemented as cloud-based solutions or non-cloud solutions. In examples disclosed herein, cloud refers to a private cloud (e.g., a self-managed or third-party managed private cloud) or a public cloud (e.g., a public cloud managed by a service provider). In examples disclosed herein, a non-cloud solution is implemented as a cluster of compute resources managed by an end user.

The VCC environment 100 may be implemented using a compute cluster of a parallel database system (e.g., an Apache® Impala® database system) provisioned in a cloud system. As such, although a single VCC environment 100 is shown, multiple VCC environments (e.g., multiple compute clusters) may be instantiated in accordance with teachings of this disclosure. For example, multiple parallel database system instances may be instantiated in the cloud system, and each parallel database system instance supports its own VCC environment. In such examples, when a client (e.g., the client device 104) submits a task processing request, a parallel database system compiles the corresponding tasks and assigns them to its corresponding VCC environment (e.g., the VCC environment 100) specified in the task processing request.

When the VCC environment 100 is created, examples disclosed herein can specify one or more fixed or static EG sizes for different EGs. Alternatively, examples disclosed herein can dynamically determine EG sizes on a per-task basis depending on characteristics (e.g., resource demands, scheduled completion time, completion duration, priorities, SLA requirements, etc.) of such tasks. In examples disclosed herein, each task that runs in the VCC environment 100 runs inside a single EG, and an EG can execute multiple tasks in parallel as long as there are sufficient resources in that EG. As more work (e.g., tasks) is added to the VCC environment 100, the WAA 102 can scale up by adding more EGs to the VCC environment 100. In accordance with examples disclosed herein, the WAA 102 can select a most-efficient EG size that is sufficiently large enough to run a task. In some examples disclosed herein, the WAA 102 selects an EG of a pre-defined fixed EG size that best matches resource demands of the task. In other examples, the WAA 102 dynamically defines an EG size of an EG to match the resource demands of the task.

In some examples, the WAA 102 configures EGs to use different compute instances. For example, the WAA 102 may schedule a memory-intensive task on an EG that includes a compute instance with a large memory and, thus, is suitable for processing memory-heavy tasks. In the same example, the WAA 102 could schedule a CPU-intensive task on an EG that includes a compute instance with a large number of cores and, thus, is suitable for executing compute-intensive tasks. An example planner (e.g., the planner 118) can generate suitable plans for a task based on available resources in a given EG.

The VCC environment 100 includes one or more example shared pool(s) of compute resources 108. As used herein, a shared pool of compute resources 108 is a logical representation of resources allocated to a pool such that tasks running in the pool can only use the resources allocated to the pool. The shared pools of compute resources 108 include compute resources that are referred to herein as executors. The executors in the shared pools of compute resources 108 are free and available to be allocated to an EG to process one or more tasks submitted by the client device 104. In some examples, the shared pool of compute resources 108 is a pool of inactive and/or shutdown executors that incur minimal or no cost and are readily available for use by requesting EG sets. In some examples, the shared pool of compute resources 108 are shared by multiple EG sets and/or multiple VCCs.

In examples disclosed herein, at creation time of the VCC environment 100 by a database warehouse system (e.g., a Cloudera® database warehouse (CDW)), a user can specify multiple fixed or static EG sizes for different EG sets. As used herein, an EG set includes one or more EGs of the same EG size. In some examples, the data warehouse system creates a separate shared pool of compute resources 108 for each EG set of a corresponding EG size. Alternatively, one shared pool of compute resources 108 can be created for multiple EG sets of different fixed EG sizes and/or dynamic EG sizes. To configure EGs to use different compute instances, there could be separate pools for EGs at different levels (e.g., an EG set level, a VCC level, multiple VCC levels, or other such extensions). Separate pools for EGs could also be provided in VCC deployment models. For example, to conduct developer testing, a VCC with a shared pool at multiple VCC levels may suffice if SLA requirements are not strict for such testing. In production VCCs, the shared pools could be at the desired level based on requirements.

Based on resource demands of workloads, the WAA 102 can scale up or scale down the number of EGs instantiated in an EG set. For example, upon receipt of a workload having multiple tasks, the WAA 102 can instantiate a first EG in an EG set (e.g., by allocating executors from a shared pool of compute resources 108) to process a first task of the workload and can instantiate a second EG in the same EG set to process a second task of the workload.

The WAA 102 can perform dynamic provisioning of mixed workloads based on two or more EG sets of differently sized EGs instead of a one-size-fits-all EG size. For example, when the VCC environment 100 includes a smaller-size EG set (e.g., each executor group in the executor group set includes two executors) and a larger-size EG set (e.g., each executor group in the executor group set includes eight executors), an incoming workload can cause the WAA 102 to provision additional compute resources by spinning up a smaller-size EG set or a larger-size EG set. The WAA 102 can select one of the smaller-size or larger-size EG sets based on the number of executors needed to process the incoming workload.

In some examples, the VCC environment 100 includes a single shared pool of compute resources 108. In such examples, the single shared pool of compute resources 108 includes executors that can be allocated to instantiate differently sized EGs (e.g., fixed-size EGs and dynamically sized EGs). As such, the single shared pool of compute resources 108 supports, for example, an EG set of dynamically sized EGs, an EG set of 2-executor-size EGs, an EG set of 4-executor-size EGs, an EG set of 8-executor-size EGs, etc.

In other examples, the VCC environment 100 includes multiple shared pools of compute resources 108. In such examples, each shared pool of compute resources 108 is created for a corresponding EG set of fixed-size or dynamically sized EGs. For example, three shared pools of compute resources 108 can be created for corresponding ones of an EG set of 2-executor-size EGs, an EG set of 4-executor-size EGs, and an EG set of 8-executor-size EGs. Additionally or alternatively, a first shared pool of compute resources 108 can be created for an EG set of dynamically sized EGs and a second shared pool of compute resources 108 can be created for another EG set of dynamically sized EGs. Fewer or more shared pools of compute resources 108 can be created for fewer or more fixed-size or dynamically sized EG sets.

The VCC environment 100 includes one or more example admission queue(s) 112. As used herein, the admission queues 112 are used to queue incoming tasks to be processed by EGs in the shared pool of compute resources 108 and to maintain servicing fairness (e.g., order of receipt, order of priority, etc.) in the presence of concurrent tasks.

For examples in which multiple shared pools of compute resources 108 are created, each shared pool of compute resources 108 is assigned a corresponding one of the admission queues 112 to execute tasks queued in its admission queue 112. For example, an EG instantiated from a shared pool of compute resources 108 executes tasks queued in an admission queue 112 of that shared pool of compute resources 108.

In other examples, admission queues 112 are assigned at the EG set level. For example, multiple admission queues 112 can be created so that each of the admission queues 112 can be assigned to a different EG set regardless of whether a single shared pool of compute resources 108 or multiple shared pools of compute resources 108 provide the executors for EGs in the different EG sets. Accordingly, if the VCC environment 100 is configured to include a small EG set (e.g., of EG size two), a medium EG set (e.g., of EG size four), and a large EG set (e.g., of EG size six), one queue (e.g., a small EG queue) of the admission queues 112 can be assigned to the small EG set, another queue (e.g., a medium EG queue) of the admission queues 112 can be assigned to the medium EG set, and yet another queue (e.g., a large EG queue) of the admission queues 112 can be assigned to the large EG set. In this manner, when small EGs are instantiated in the small EG set, each of the small EGs can execute one or more tasks from the small EG queue of the admission queues 112. Similarly, when medium EGs are instantiated in the medium EG set and large EGs are instantiated in the large EG set, each of the medium and large EGs can execute one or more tasks from corresponding ones of the medium EG queue and the large EG queue of the admission queues 112.

The admission queues 112 may be implemented in any suitable memory including, for example, dynamic random-access memory (DRAM), static random-access memory (SRAM), flash memory, cache, or any other suitable types of memory.

In example FIG. 1, the WAA 102 includes an example client interface 114, an example cost estimator 116, an example planner 118, an example workload-aware autoscaler (WAA) scheduler 122, and an example queue interface 124. The client interface 114 is provided to exchange communications with client devices such as a client device 104. For example, the client interface 114 may receive task processing requests from the client device 104 and provide task processing results to the client device 104. In some examples, the client interface 114 may be implemented using an application programming interface (API). The cost estimator 116 is provided to determine cost estimates for processing tasks requested by the client device 104. For example, the cost estimator 116 may estimate data storage resource costs (e.g., storage capacity), memory resource cost (e.g., memory capacity), processor resource costs (e.g., processor cycles, processor cores, cash size, etc.), network resource costs (e.g., bandwidth), or any other resource costs incurred to process tasks.

The planner 118 is provided to generate distributed execution plans for tasks. In some examples, when there are multiple shared pools of compute resources 108 for corresponding EG sets, the planner 118 generates multiple distributed execution plans for a task such that each of the distributed execution plans is optimized for a different one of the shared pools of compute resources 108. In other examples, the planner 118 generates different distributed execution plans on a per-EG-set basis in which each of the distributed execution plans corresponds to a respective EG set regardless of the number of shared pools of compute resources 108.

In some examples, a distributed execution plan specifies how many executors are to be allocated to process a corresponding task. The number of executors allocated for a task is based on the resource demands of that task. For example, resource demands can be referenced based on units of resources such as memory resources, CPU resources, storage resources, input/output (I/O) resources, etc. In addition, a service level agreement (SLA) associated with a task is taken into account when determining the resources and/or number of resources to be allocated to process that task. For example, a task can be executed on four executors and eight executors but using different numbers of executors to execute the task will have different associated performances and costs. As such, if resource demands for a task require four executors, and one or more shared pools of compute resources 108 support EG sizes of two executors (e.g., 2-executor-size EGs), four executors (e.g., 4-executor-size EGs), and eight executors (e.g., 8-executor-size EGs), the planner 118 creates two different distributed execution plans. The first distributed execution plan for the 2-executor-size EGs may be executable but will indicate that more compute resources will improve performance. The second distributed execution plan for the 4-executor-size EGs may specify that the query is both executable and unlikely to benefit from further increasing compute resources. As another example illustration, if data is partitioned into four partitions, then at most, four executors would be needed to execute the task of that data. Similarly when lots of partitions exist for a task, some of the partitions could be redistributed further if an 8-executor-size EG is used instead of a 4-executor-size EG. After the planner 118 determines that additional compute resources are not desired, it may skip generation of additional execution plans for larger EGs.

The WAA scheduler 122 is provided to automatically schedule tasks based on resource requirements (or any other suitable condition(s) described below) to one of the shared pools of compute resources 108 having the right-sized EG. The WAA scheduler 122 evaluates whether a task can be run in available shared pools of compute resources 108. When the WAA scheduler 122 finds a resource pool that can efficiently run the task, it allocates the task to that resource pool.

The WAA scheduler 122 scales up and scales down EG instances (e.g., adds and deletes EGs) in response to system load in the VCC environment 100. As used herein, system load refers to a number of resources allocated at any point in time to EGs for use in executing tasks. The WAA scheduler 122 does this by monitoring system load metrics produced by, for example, a parallel database system in which the VCC environment 100 is instantiated. In examples disclosed herein, the system load metrics are enhanced to have information about tasks queued in the admission queues 112. When there are queued tasks, the WAA scheduler 122 can add and delete EGs of the appropriate sizes to scale up or scale down the VCC environment 100.

Queued tasks may cause EGs to be added, and empty EGs may be deleted. Additions and deletions of EGs could be governed by one or more policies. Examples of such policies include time-based EG additions/deletions, pattern-based EG additions/deletions, headroom-based EG additions, SLA-based EG additions/deletions, cost/resource-based EG additions/deletions, schedule-based EG additions/deletions, or any combination thereof. In time-based EG scaling (e.g., EG additions/deletions), a queued task for x time causes an EG addition and an empty EG for x time causes an EG deletion. In pattern-based EG scaling (e.g., EG additions/deletions), configured patterns or historical pattern-based EG additions/deletions can be made. For example, on workdays EGs can be added at a start time and deleted towards an end time according to daily patterns of network traffic variations (e.g., anticipated higher loads and/or lower loads). Similarly, on busy days EGs can be added based on historical patterns. In headroom-based EG scaling (e.g., EG additions), if current EGs are nearing some capacity threshold, a new EG can be added. In SLA-based EG scaling (e.g., EG additions/deletions), for tight SLAs, EGs can be added in advance to maintain some spare capacity, and for weak SLAs, tasks could be queued for longer duration before EGs are added. In cost/resource-based EG scaling (e.g., EG additions/deletions), EGs can be added until a specified cost and/or resource limit is reached (e.g., satisfied). In schedule-based EG scaling (e.g., EG additions/deletions), EGs could be added at scheduled start times and deleted at scheduled end times.

The WAA scheduler 122 can also optimize task allocation and processing for cost performance and resource utilization by running different workloads on right sized EGs. For example, referring to the three distributed execution plans noted above for a task requiring four executors, the WAA scheduler 122 may select the shared pool of compute resources 108 corresponding to the 4-executor-size EGs because the task may be processed using a single 4-executor-size EG without any of the executors in the EG remaining idle. In some examples, the WAA scheduler 122 also considers resource availability of the different shared pools of computer resources 108 when selecting a shared pool of compute resources to process a task. For example, if the shared pool of compute resources 108 corresponding to the 4-executor-size EGs does not have enough resources to form an EG, the WAA scheduler 122 may instead select the shared pool of compute resources 108 corresponding to the 8-executor-size EGs even though four executors will remain idle. In some examples, the task can be redistributed to an 8-executor-size EG and executed on all eight executors of the 8-executor-size EG.

In examples disclosed herein, the WAA scheduler 122 takes service level agreement (SLA) requirements of tasks into account when making scheduling decisions such as optimizing for cost, performance, or both. As used herein, performance refers to a processing speed of an EG in completing a task or an amount of time for an EG to complete a task. In some examples, the WAA scheduler 122 is also configured to independently scale different EGs as a system load varies.

The WAA scheduler 122 may include SLA controls to make scheduling and scaling decisions. For example, an SLA control may cause the WAA scheduler 122 to promote an incoming task to run on an already running, but bigger EG to meet SLA requirements. In other examples, scaling up or scaling down could be done based on an expected schedule (e.g., schedule-based autoscaling). Also, for tight SLA tasks, the WAA scheduler 122 could keep related EGs always running to meet those SLA task requirements. In some examples, the WAA scheduler 122 is also configured to receive user input to allow users to influence or override the decisions made by the WAA scheduler 122.

The queue interface 124 is provided to enqueue tasks in the admission queue(s) 112 and to access tasks from the admission queue(s) 112. For example, the queue interface 124 may enqueue tasks for which the planner 118 has generated distributed execution plans. In addition, the queue interface 124 may access tasks from the admission queue(s) 112 for the WAA scheduler 122 to assign to an EG in a shared pool of compute resources 108 for processing.

The WAA 102 of FIG. 1 may be instantiated (e.g., creating an instance of, bring into being, materialize, implement, etc.) by programmable circuitry such as a Central Processor Unit (CPU) executing instructions. Additionally or alternatively, the WAA 102 of FIG. 1 may be instantiated (e.g., creating an instance of, bring into being, materialize, implement, etc.) by (i) an Application Specific Integrated Circuit (ASIC) and/or (ii) a Field Programmable Gate Array (FPGA) structured and/or configured to perform operations of the WAA 102. It should be understood that some or all of the circuitry of FIG. 1 may be instantiated at the same or different times. Moreover, in some examples, some or all of the circuitry of FIG. 1 may be implemented by microprocessor circuitry executing instructions and/or FPGA circuitry performing operations to implement one or more virtual machines and/or containers.

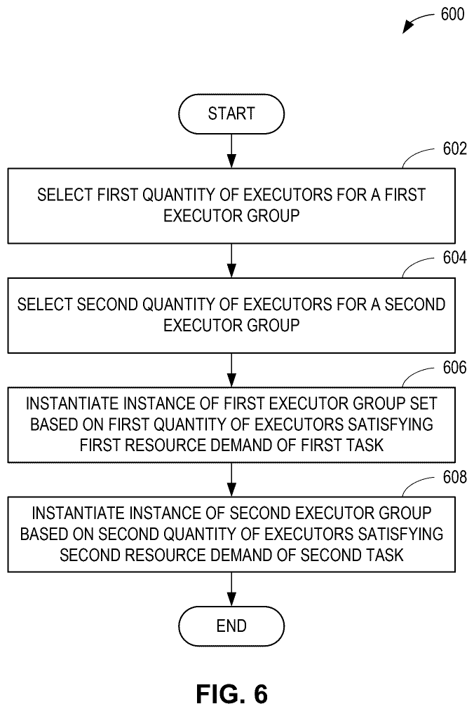

In some examples, the client interface 114, the cost estimator 116, the planner 118, the WAA scheduler 122, and the queue interface 124 are circuitry (e.g., the client interface circuitry, the cost estimator circuitry, the planner circuitry, the WAA scheduler circuitry, and the queue interface circuitry) instantiated by programmable circuitry executing instructions and/or configured to perform operations such as those represented by the flowcharts of FIGS. 6-10.

As described above, the client interface 114, the cost estimator 116, the planner 118, the WAA scheduler 122, and the queue interface 124 of FIG. 1 are structures. Such structures may implement means for performing corresponding disclosed functions. Examples of such functions are described above in connection with corresponding ones of the client interface 114, the cost estimator 116, the planner 118, the WAA scheduler 122, and the queue interface 124 and are described below in connection with the flowcharts of FIGS. 6-10.

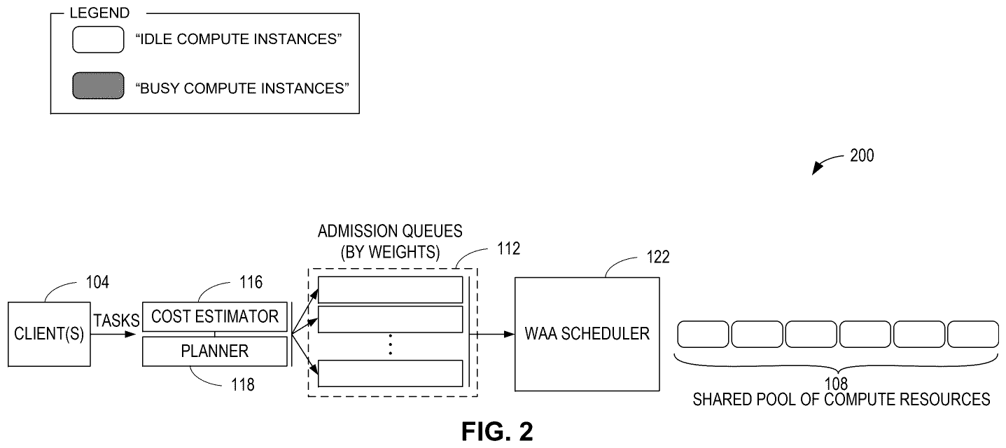

FIG. 2 is an example dynamic executor group size VCC environment 200 in which the WAA 102 of FIG. 1 can scale up or scale down executor group sizes based on different scale up or scale down conditions. For purposes of brevity, example FIG. 2 shows the cost estimator 116, the planner 118, and the WAA scheduler 122 of the WAA 102 of FIG. 1, but does not show other components of the WAA 102. However, the example of FIG. 2 employs such other components such as the client interface 114 to receive task processing requests from one or more client devices 104 and the queue interface 124 to access the admission queues 112. In the dynamic executor group size VCC environment 200 of FIG. 2, the WAA 102 performs dynamic formation of one or more EGs using executors from the shared pool of compute resources 108. In example FIGS. 2, 3A, 3B, 4, and 5A-5D, blocks representative of executors or compute resources (e.g., compute resources in the shared pool of compute resources 108 or in executor groups 304a-c, 402a-c, and 502a-c) are unshaded to indicate idle compute instances and shaded to indicate busy compute instances.

In example FIG. 2, one or more client devices 104 provide one or more requests to process multiple tasks. The cost estimator 116 generates cost estimates to run the tasks in differently sized EGs. The cost estimator 116 uses an execution model and other relevant information to generate cost estimates for executing a task on a given EG. The planner 118 generates distributed execution plans for the different tasks based on the execution model, the cost estimates, and/or one or more conditions associated with scaling up or scaling down EGs in the dynamic executor group size VCC environment 200. Example scale up or scale down conditions associated with such scaling up or scaling down include system load, workload demands, scheduled times, historical use data, resource demands or requirements of tasks or workloads, etc.

As used herein, system load refers to a number of resources allocated at any point in time to EGs for use in executing tasks. As used herein, workload demands refers to a demand for resources by tasks queued in the admission queue(s) 112 and awaiting to be processed. For example, when system load is high and a workload demand of queued tasks requires additional resources, the WAA scheduler 122 can determine to start up executors (e.g., compute resources) to instantiate one or more new EGs to execute the tasks. Alternatively, when system load is low and a workload demand is also low, the WAA scheduler 122 shuts down and releases the executors (e.g., compute resources) of one or more EGs. For example, the WAA scheduler 122 can release the executors back to the shared pool(s) of compute resources 108 so that they are available to be allocated to subsequently instantiated EGs.

To perform such scale up or scale down operations, the WAA scheduler 122 may be configured to do so based on the system load and/or workload demand. Alternatively, the planner 118 can create one or more distributed execution plans for an input task based on the system load and/or workload demand to cause the WAA scheduler 122 to perform the scale up or scale down operations.

As used herein, scheduled times refers to times at which EGs are scheduled to be scaled up or scaled down in schedule-based EG scaling. Such scheduled times may be based on when system load and/or workload demand throughout a day, week, month, etc. are to require more or less EGs. As such, based on a first time specified in a schedule, the WAA scheduler 122 can instantiate one or more EGs or scale up executors in one or more already instantiated EGs in the dynamic executor group size VCC environment 200. In addition, based on a second time specified in the schedule, the WAA scheduler 122 can release one or more EGs or scale down executors in one or more EGs. For example, in a typical workday, the hours between 9:00 AM and 5:00 PM can experience the highest system load and workload demands. As such, scaling up operations can be scheduled to occur at 8:30 AM in preparation for the start of peak activity at 9:00 AM. In addition, scaling down operations can be scheduled to occur at 5:30 PM, after peak activity hours. In other examples, there could be more than two scheduled time intervals for schedule-based scaling. For example, multiple scheduled start times could be created to add different EGs at different times and multiple scheduled end times could be created to delete different EGs at different times. An example of such scheduling could be to scale up at 8:30 AM, scale down at 5:00 PM, and scale up again and/or scale down again at some other time(s). To perform such scale up or scale down operations, the WAA scheduler 122 may be configured to do so based on the scheduled times.

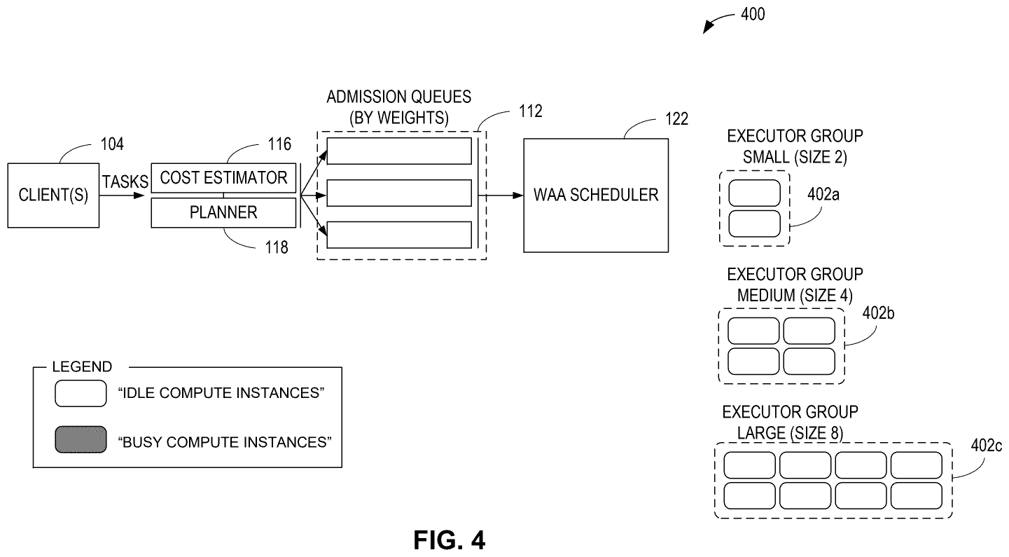

As used herein, historical use data refers to data representative of historical use patterns or historical use trends of EGs to process tasks. The historical use data can be stored in a historical database and be indicative of when past system load and/or past workload demand of past days, weeks, months, years, etc. represent more or less use of EGs. Such historical data can be used to predict when future system load and/or future workload demand are to be low or high at future dates and times. In this manner, the WAA scheduler 122 can be programmed to proactively respond to such predicted dates and times by scaling up or scaling down EGs. For example, based on historical use data, the WAA scheduler 122 can instantiate one or more EGs or scale up executors in one or more already instantiated EGs in the dynamic executor group size VCC environment 200 or in a static executor group size VCC environment (e.g., the static executor group size VCC environment 400 of FIG. 4). In addition, based on the historical use data, the WAA scheduler 122 can release one or more EGs or scale down executors in one or more EGs. To perform such scale up or scale down operations, the WAA scheduler 122 may be configured to do so based on the historical use data.

As used herein, a resource demand refers to a number of executors needed to execute a task. As used herein, a requirement of a task or workload refers to one or more conditions or criteria that need to be satisfied by execution of a task. For example, a condition or criterion may be that the task needs to be completed by a particular time of day or that the task needs to be completed within a particular duration.

The planner 118 assigns or enqueues incoming tasks in corresponding ones of the admission queues 112 based on one or more distributed execution plans. In some examples, the planner 118 enqueues the incoming tasks in corresponding ones of the admission queues 112 based on weightage values that are generated using cost estimations and/or requirements of SLAs maintained for different ones of the client devices 104. For example, if there are multiple queues (e.g., the admission queues 112) per EG set and each queue has a different weight or priority, incoming tasks are assigned to these priority queues based on their SLAs or priorities. In such examples, the WAA scheduler 122 includes logic (e.g., circuitry or machine-executable instructions) to schedule tasks from the priority queues onto EGs based on the priorities of the tasks. In some examples, differently sized tasks are not mixed into the same priority queue. Instead, differently sized EGs are associated with respective priority queues so that priority-based task scheduling can be aligned with corresponding ones of the differently sized EGs. In this manner, different EG sizes can be selected for higher-priority or lower-priority task execution. In some examples, multiple priority queues are instantiated per EG set.

The WAA scheduler 122 dynamically determines an EG size for each task enqueued in the admission queues 112. The WAA scheduler 122 also forms EGs from available executors in the shared pool of compute resources 108. For example, the WAA scheduler 122 can form an EG for a task in the admission queue 112 based on the compute resource requirements and the SLA requirements of the task.

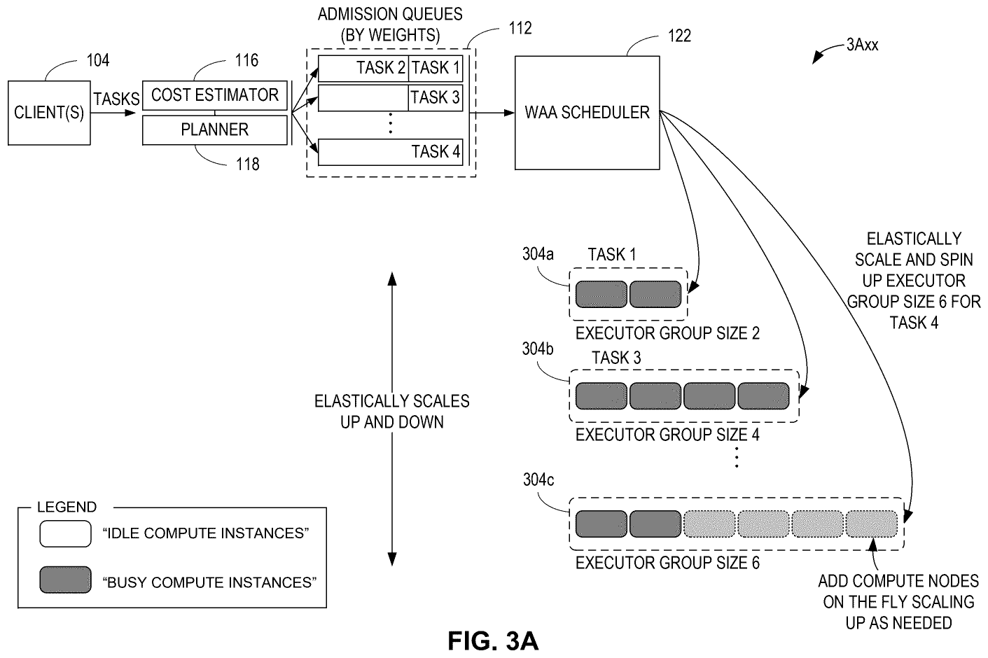

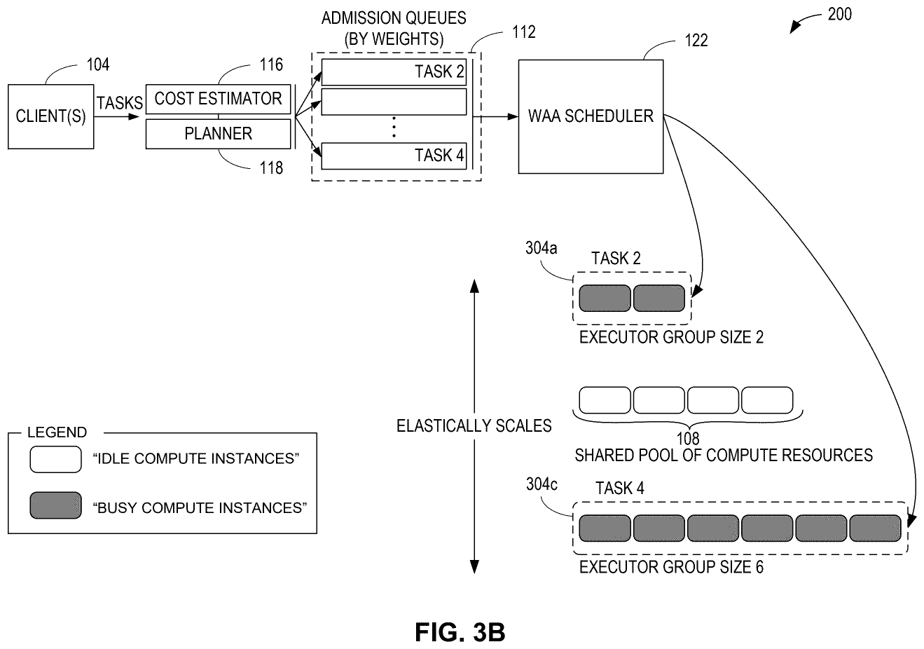

FIGS. 3A and 3B show the example dynamic executor group size VCC environment 200 of FIG. 2 in which EG sizes are scaled up and scaled down based on scale up or scale down conditions. In example FIG. 3A, the WAA scheduler 122 schedules incoming tasks by elastically scaling executors (e.g., compute resources) from the shared pool of compute resources 108 up and down to dynamically form EGs. In example FIG. 3A, task 1, task 2, task 3, and task 4 are enqueued in the admission queues 112. Task 1 and task 2 are enqueued in one of the admission queues 112 corresponding to an EG size of two. Task 3 is enqueued in one of the admission queues 112 corresponding to an EG size of four. Task 4 is enqueued in one of the admission queues 112 corresponding to an EG size of six.

The WAA scheduler 122 is shown creating three executor groups 304a, 304b, 304c of EG sizes two, four, and six, respectively. For example, in response to receiving task 1 and task 2 in the corresponding one of the admission queues 112, the WAA scheduler 122 scales up the dynamic executor group size VCC environment 200 by instantiating the EG of size two 304a based on the EG of size two 304a satisfying a resource demand and/or SLA requirement of task 1 and task 2. In addition, in response to receiving task 3 in the corresponding one of the admission queues 112, the WAA scheduler 122 scales up the dynamic executor group size VCC environment 200 by instantiating the EG of size four 304b based on the EG of size four 304b satisfying a resource demand and/or SLA requirement of task 3.

Also, in FIG. 3A, in response to receiving task 4 in the corresponding one of the admission queues 112, the WAA scheduler 122 scales up the dynamic executor group size VCC environment 200 by scaling up an EG of size two to become an EG of size six 304c based on the EG of size six 304c satisfying a resource demand and/or SLA requirement of task 4. In the illustrated example, the EGs 304a, 304b, 304c can be instantiated based on an EG size that satisfies the requirements of a pending task. However, the number of executors in each of the EGs 304a, 304b, 304c can be subsequently scaled up or scaled down dynamically to provide an optimal number of compute resources for a subsequent task to be processed. Accordingly, the WAA scheduler 122 can perform the dynamic scaling up of executors in the EG 304c from two to six by spinning up an additional four executors to provide a number of executors that satisfies a resource demand and/or SLA requirement of task 4.

Turning now to example FIG. 3B, the WAA scheduler 122 scales down the dynamic executor group size VCC environment 200 by releasing executors back to the shared pool of compute resources 108. For example, in response to completion of task 3, the WAA scheduler 122 shuts down the EG 304b of FIG. 3A and releases its executors back to the shared pool of compute resources 108. In this manner, the EG 304b does not sit idle (e.g., without executing a task), and its executors again become available for use in instantiating a subsequent EG to process a subsequent task.

FIG. 4 is an example static executor group size VCC environment 400 in which the WAA 102 of FIG. 1 can scale up or scale down executor group quantities based on resource demands. For example, the WAA scheduler 122 can set, select, or configure static EG sizes for EG sets based on static EG sizes received from (e.g., configured by) administrators or users based on workloads. For purposes of brevity, example FIG. 4 shows the cost estimator 116, the planner 118, and the WAA scheduler 122 of the WAA 102 of FIG. 1, but does not show other components of the WAA 102. However, the example of FIG. 4 employs such other components such as the client interface 114 to receive task processing requests from one or more client devices 104 and the queue interface 124 to access the admission queues 112.

In example FIG. 4, the static executor group size VCC environment 400 includes a small EG 402a configured as an EG size of two, a medium EG 402b configured as an EG size of four, and a large EG 402c configured as an EG size of eight. Each of the EGs 402a, 402b, 402c belongs to a corresponding EG set (e.g., a small EG set, a medium EG set, a large EG set) that the WAA scheduler 122 can scale up by adding more EGs or scale down by removing EGs to accommodate larger or smaller workloads in the static executor group size VCC environment 400.

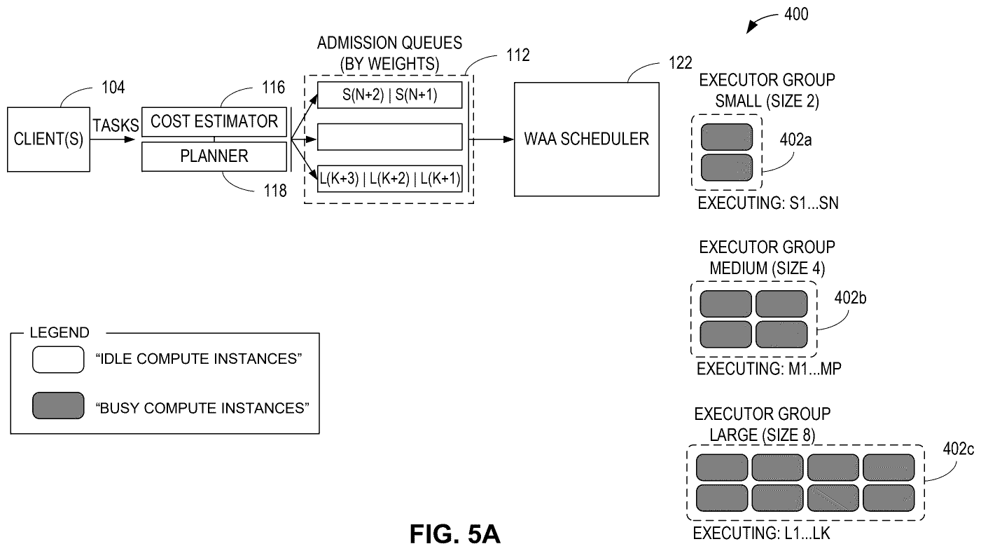

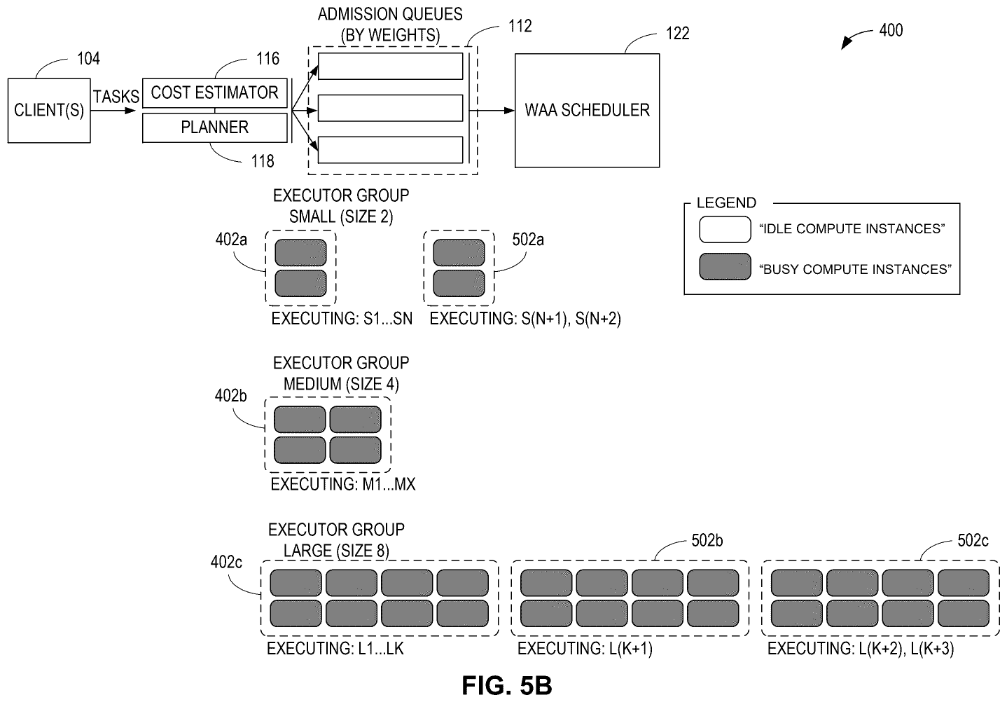

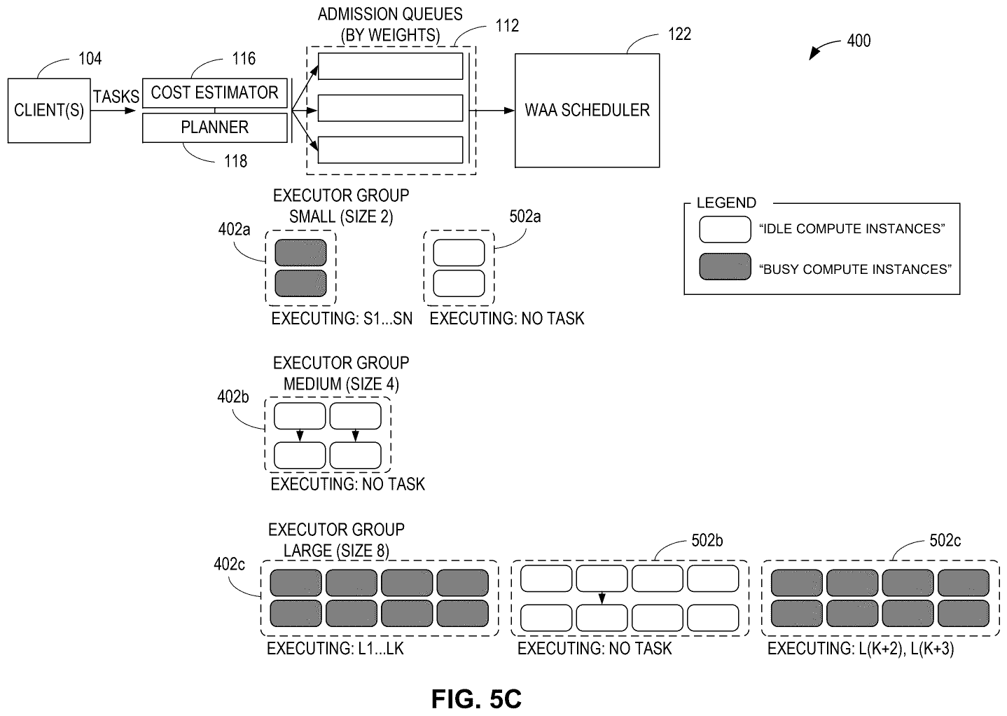

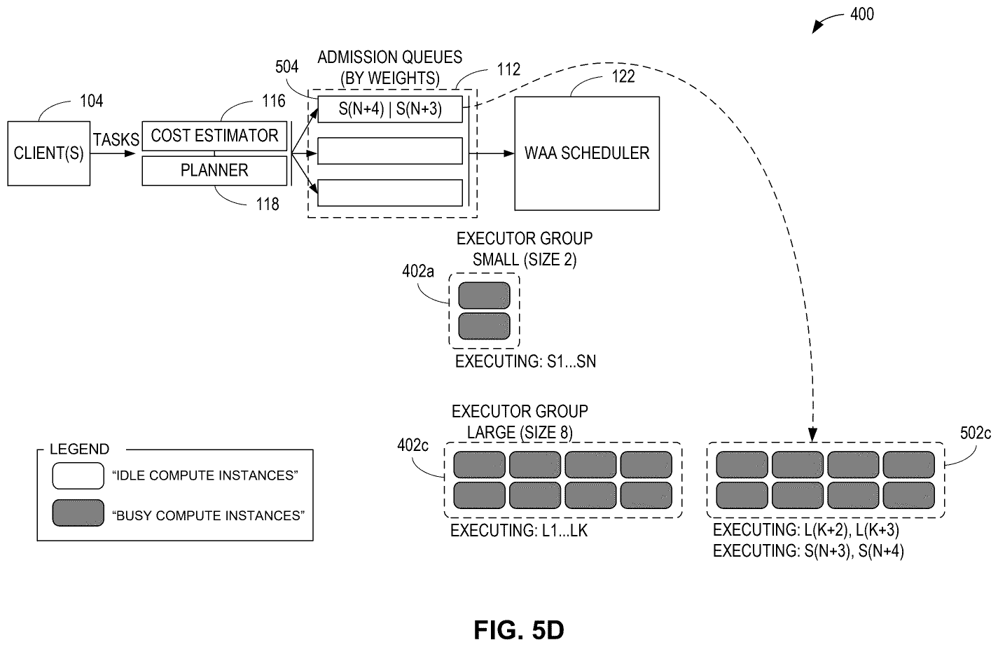

FIG. 4 represents an initial configuration of the static executor group size VCC environment 400 in which the EGs 402a, 402b, 402c are shown with unprovisioned executors. However, as incoming tasks are queued in the admission queues 112, the WAA scheduler 122 can scale up the static executor group size VCC environment 400 by provisioning executors in corresponding fixed-size EGs, as shown in FIGS. 5A and 5B. Each EG set (e.g., the small EG set, the medium EG set, and the large EG set) can be scaled up or down based on task load of the static executor group size VCC environment 400.

Turning to example FIG. 5A, the cost estimator 116 estimates costs for incoming tasks SN (e.g., Nth task for the small EG 402a), MP (e.g., Pth task for the medium EG 402b), and LK (e.g., Kth task for the large EG 402c). The planner 118 assigns the tasks SN, MP, LK to corresponding ones of the admission queues 112 based on weightage (e.g., compute cost estimation and/or SLA requirements). At any point in time, the static executor group size VCC environment 400 could have some tasks executing and some tasks queued. For example, the WAA scheduler 122 can instantiate each of the small EG 402a, the medium EG 402b, and the large EG 402c to process corresponding tasks while other tasks such as tasks S(N+2), S(N+1), L (K+3), L (K+2), L (K+1) are enqueued in the admission queues 112.

Turning to example FIG. 5B, the static executor group size VCC environment 400 can accommodate new tasks by triggering autoscaling. For example, to process the tasks S(N+2), S(N+1), L (K+3), L (K+2), L (K+1) shown as enqueued in the admission queues 112 in FIG. 5A, the WAA scheduler 122 can instantiate additional EGs to process those tasks. In example FIG. 5B, the WAA scheduler 122 instantiates an additional small EG 502a to execute tasks S(N+1) and S(N+2) and instantiates two additional large EGs 502b, 502c to execute tasks L (K+1), L (K+2), and L (K+3). The small EGs 402a, 502a are part of a small EG set. The large EGs 402c, 502b, 502c are part of a large EG set.

In examples disclosed herein, multiple tasks can share the same EG. In the illustrated example of FIG. 5B, the tasks S(N+1) and S(N+2) are executed in the same small EG 502a because each of the tasks has a resource demand of one executor for a total of two executors to execute both tasks. In other words, together both tasks have resource requirements (e.g., CPU resources, memory resources, storage resources, I/O resource, etc.) that can be accommodated in a single small EG. Also in the illustrated example, the tasks L (K+2) and L (K+3) can be executed in the same large EG 502c because the combined resource demands of those tasks amount to a total sum of eight executors.

FIG. 5C shows scaling down of resources in the example static executor group size VCC environment 400 of FIG. 4 based on resource capacity and system load. For example, if at some point in time the EG capacity is more than a current task load in the static executor group size VCC environment 400, the WAA scheduler 122 scales down EGs which are no longer required. The scaled down resources could be cached locally in a corresponding EG (e.g., for future use) or returned to the shared pool of compute resources 108 and cached at the shared pool of compute resources 108. To cache resources locally in EGs, the WAA scheduler 122 spins down or shuts down executors in the EGs to an inactive state but keeps the executors and EGs in standby without releasing the executors back to the shared pool of compute resources 108. In this manner, the inactive executors remain allocated to their respective EGs. Inactive executors in a locally cached state (e.g., a standby state) incur no significant delay associated with re-allocating them back from the shared pool of compute resources 108 to an EG. Instead, they are readily available and already allocated in an EG to spin up again to process a subsequent task received at the static executor group size VCC environment 400. Executors that are returned to and cached at the shared pool of compute resources 108 could incur delays when re-allocating them to EGs from the shared pool of compute resources 108. For example, the delays could be incurred if there are other competing EG sets and/or VCCs requesting the same executors.

In example FIG. 5C, when the small EG 502a, the medium EG 402b, and the large EG 502b are not executing tasks, their executors are idle. In response to the WAA scheduler 122 detecting that these EGs 502a, 402b, 502b are idle, the WAA scheduler 122 spins down or shuts down the executors of the EGs 502a, 402b, 502b to inactive states. In the illustrated example of FIG. 5C, the WAA scheduler 122 maintains the executors of the EGs 502a, 402b, 502b in a cached state (e.g., a standby state). Otherwise, if the WAA scheduler 122 releases the executors back to the shared pool of compute resources 108, the EGs 502a, 402b, 502b are removed from their respective EG sets.

FIG. 5D shows promotion of tasks between executor groups in the example static executor group size VCC environment 400 of FIG. 4 based on SLAs. The WAA scheduler 122 can decide to promote tasks to satisfy requirements of SLAs. For example, if a first task is enqueued in a first one of the admission queues 112 corresponding to a first EG and a second task is enqueued in a second one of the admission queues 112 corresponding to a second EG, the WAA scheduler 122 can promote a third task from a third one of the admission queues 112 corresponding to a third EG to the first one of the admission queues 112 corresponding to the first EG based on an SLA requirement of the third task. For example, the SLA requirement can specify that the third task is to be completed by a particular time or within a particular duration that can be satisfied by the first EG associated with the first one of the admission queues 112.

In example FIG. 5D, the WAA scheduler 122 promotes the tasks S(N+3) and S(N+4) from a small EG queue 504 of the admission queues 112 to be executed on the large EG 502c. For example, the WAA scheduler 122 can promote the tasks S(N+3) and S(N+4) based on their size and based on complying with SLA requirements. For example, because both of the tasks S(N+3) and S(N+4) are small tasks, the WAA scheduler 122 can determine that they both simultaneously fit in the large EG 502c but not in the currently provisioned small EG 402a. That is, the WAA scheduler 122 can determine that the resource capacity (e.g., the quantity of executors) of the large EG 502c satisfies (e.g., is greater than or equal to) the sum of the combined resource demands of the tasks S(N+3) and S(N+4). In addition, the WAA scheduler 122 can determine that autoscaling the small EG 402a to include more executors could cause SLA failures (e.g., failure to satisfy SLA requirements) for these tasks S(N+3) and S(N+4).

While an example manner of implementing the WAA 102 of FIG. 1 is illustrated in FIGS. 1, 2, 3A, 3B, 4 and 5A-5C, one or more of the elements, processes, and/or devices illustrated in FIGS. FIGS. 1, 2, 3A, 3B, 4 and 5A-5C may be combined, divided, re-arranged, omitted, eliminated, and/or implemented in any other way. Further, the example client interface 114, the example cost estimator 116, the example planner 118, the example WAA scheduler 122, and the example queue interface 124, and/or, more generally, the example WAA 102 of FIG. 1, may be implemented by hardware alone or by hardware in combination with software and/or firmware. Thus, for example, any of the example client interface 114, the example cost estimator 116, the example planner 118, the example WAA scheduler 122, and the example queue interface 124, and/or, more generally, the example WAA 102, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example WAA 102 of FIG. 1 may include one or more elements, processes, and/or devices in addition to, or instead of, those illustrated in FIG. 1, and/or may include more than one of any or all of the illustrated elements, processes and devices.

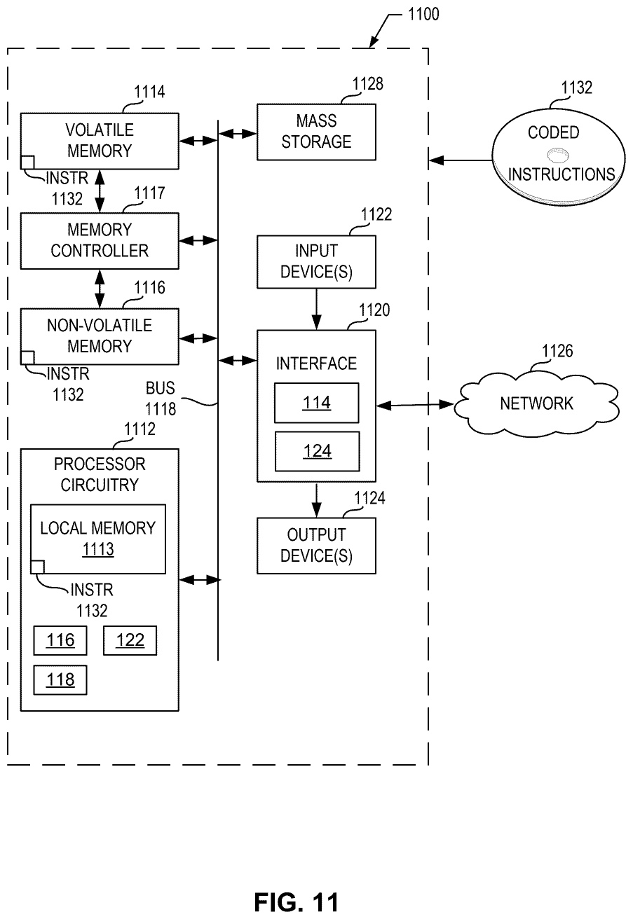

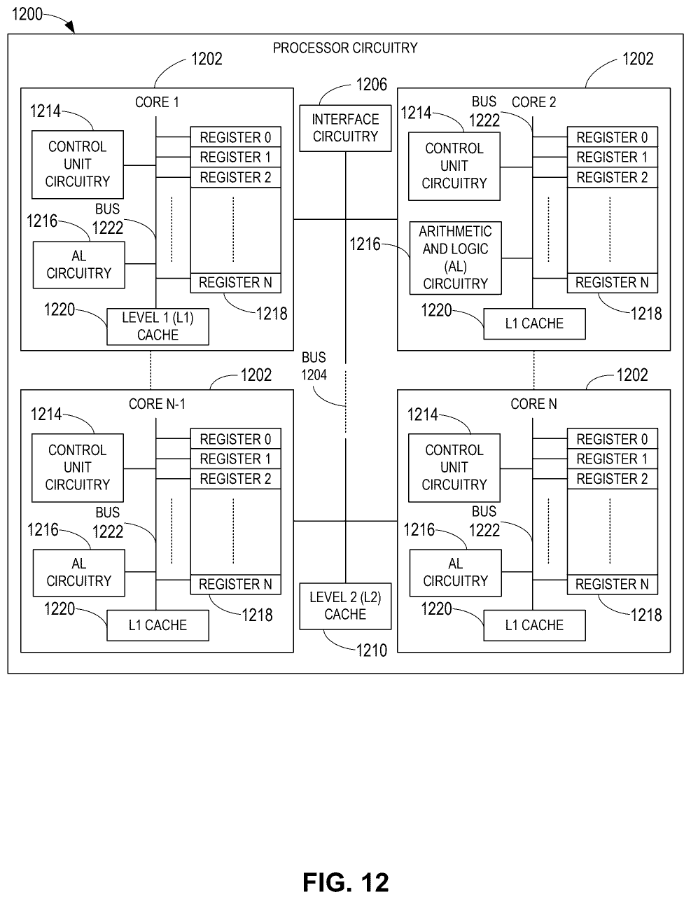

Flowcharts representative of example machine-readable instructions, which may be executed by programmable circuitry to implement and/or instantiate the WAA 102 of FIG. 1 and/or representative of example operations which may be performed by programmable circuitry to implement and/or instantiate the WAA 102 of FIG. 1, are shown in FIGS. 6-10. The machine-readable instructions may be one or more executable program(s) or portion(s) of one or more executable program(s) for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer readable storage medium may include one or more mediums and/or types of mediums. The instructions of the non-transitory computer readable and/or machine-readable medium may be executed and/or instantiated by one or more hardware devices other than the programmable circuitry and/or may be embodied in dedicated hardware. For example, any or all of the blocks of the flowchart(s) may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowchart(s) illustrated in FIGS. 6-10, many other methods of implementing the example WAA 102 may alternatively be used. For example, the order of execution of the blocks of the flowchart(s) may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

Machine-readable instructions as described herein may be stored as data and/or in a data structure (e.g., as portion(s) of instructions, code, representations of code, etc.) on one or more storage devices, disks and/or computing devices (e.g., servers) located at the same or different locations of a network or collection of networks (e.g., in the cloud, in edge devices, etc.).

The machine-readable instructions described herein can be written or represented using any suitable previously developed or future-developed instruction language, scripting language, programming language, etc. including, for example, C, C++, Java, C#, Perl, Python, JavaScript, HyperText Markup Language (HTML), Structured Query Language (SQL), Swift, etc.

As mentioned above, the example operations of FIGS. 6-10 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform. Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIG. 6 is a flowchart representative of example machine-readable instructions and/or example operations 600 that may be executed, instantiated, and/or performed by example programmable circuitry to implement the WAA 102 of FIG. 1. The example machine-readable instructions and/or example operations 600 of FIG. 6 begin at block 602, at which the WAA scheduler 122 selects a first quantity of executors for a first EG in a VCC (e.g., the VCC environment 100 of FIG. 1, the VCC environment 200 of FIG. 2, or the VCC environment 400 of FIG. 4). The WAA scheduler 122 selects a second quantity of executors for a second EG in the VCC (block 604). The first quantity of executors of the first EG is different from the second quantity of executors of the second EG. For example, the first quantity of executors may be two (e.g., for the EG of size two 304a of FIG. 3A or the small EG 402a having an EG size of two of FIG. 4) and the second quantity of executors may be four (e.g., the EG of size four 304b of FIG. 3A or the medium EG 402b having an EG size of four of FIG. 4). In other examples, any other quantities of executors may be selected.

The WAA scheduler 122 instantiates an instance of the first EG in the VCC based on the first quantity of executors satisfying a first resource demand of a first task (block 606). For example, the WAA scheduler 122 can instantiate the instance of the first EG in response to the first task being received from a client device (e.g., the client device 104 of FIGS. 1, 2, 3A, 3B, 4, and 5A-5D) and enqueued in the admission queues 112 (FIGS. FIGS. 1, 2, 3A, 3B, 4, and 5A-5D).

The WAA scheduler 122 instantiates an instance of the second EG in the VCC based on the second quantity of executors satisfying a second resource demand of a second task (block 608). For example, the WAA scheduler 122 can instantiate the instance of the second EG in response to the second task being received from a client device (e.g., the client device 104) and enqueued in the admission queues 112. The example instructions and/or operations 600 end.

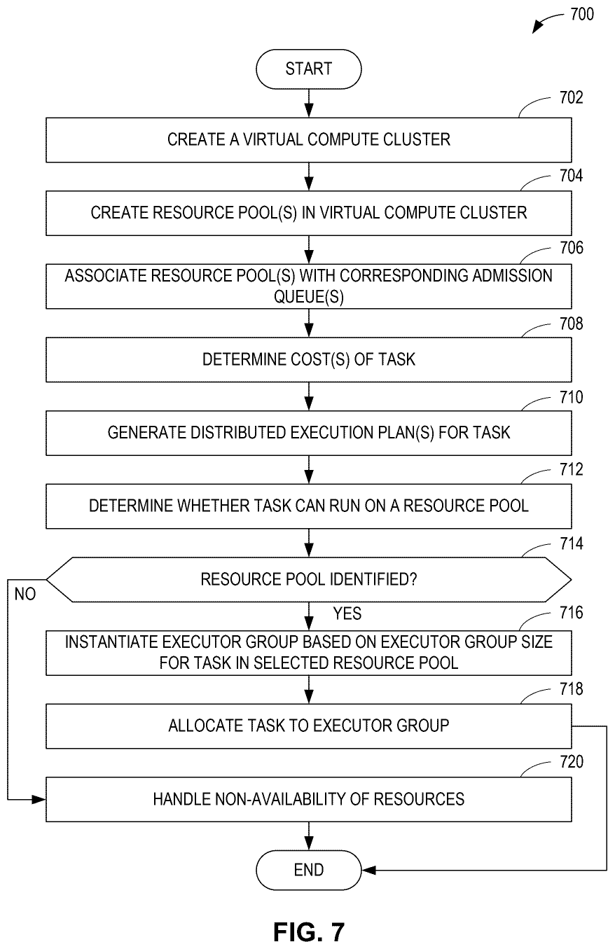

FIG. 7 is another flowchart representative of example machine-readable instructions and/or example operations 700 that may be executed, instantiated, and/or performed by example programmable circuitry to implement the WAA 102 of FIG. 1. The example machine-readable instructions and/or example operations 700 of FIG. 7 begin at block 702, at which a database warehouse (e.g., a Cloudera® database warehouse (CDW)) creates a virtual compute cluster (VCC). For example, the database warehouse can instantiate any of the VCC environments 100 (FIG. 1), 200 (FIG. 2), or 400 (FIG. 4). The WAA scheduler 122 (FIG. 1) creates one or more resource pool(s) in the VCC environment (block 704). For example, the WAA scheduler 122 can create one or more of the shared pool(s) of compute resources 108 (FIG. 1).

The WAA scheduler 122 associates the resource pool(s) with corresponding admission queue(s) (block 706). For example, the WAA scheduler 122 can associate one or more of the shared pool(s) of compute resources 108 with corresponding queues in the admission queues 112 (FIG. 1). The cost estimator 116 (FIG. 1) determines one or more cost(s) of a task (block 708). For example, after the client interface 114 (FIG. 1) receives a task from the client device 104 (FIG. 1), the cost estimator 116 estimates one or more costs associated with executing the task.

The planner 118 (FIG. 1) generates one or more distributed execution plan(s) for the task (block 710). The WAA scheduler 122 determines whether the task can run on a resource pool (block 712). For example, the WAA scheduler 122 determines whether one of the shared pool(s) of compute resources 108 has sufficient executors (e.g., compute resources) to satisfy the resource demands of the task. Such a decision can be made by the WAA scheduler 122 determining whether the resources in the shared pool(s) of compute resources 108 can support the cost(s) of the task and/or satisfy one or more SLA requirements of the task. In some examples, the WAA scheduler 122 makes the determination of block 712 on a static EG size basis. In a static EG size example, if multiple shared pools of compute resources 108 support multiple corresponding EG sizes, the WAA scheduler 122 determines whether any of those EG sizes support the cost(s) of the task and/or satisfy the resource demands and/or SLA requirement(s) of the task. Alternatively, in a dynamic EG size example, the WAA scheduler 122 determines whether a number of available executors in any of the shared pool(s) of compute resources 108 is sufficient to allocate dynamically defined number of executors in an EG to support the cost(s) of the task and/or satisfy the resource demands and/or SLA requirement(s) of the task.

If the WAA scheduler 122 identifies a resource pool (e.g., one of the shared pool(s) of compute resources 108) (block 714: YES), the WAA scheduler 122 instantiates an EG based on an EG size for the task in the selected one of the shared pool(s) of compute resources 108 (block 716). The WAA scheduler 122 allocates the task to the EG (block 718). Alternatively, if the WAA scheduler 122 does not identify a resource pool (e.g., one of the shared pool(s) of compute resources 108) (block 714: NO), control advances to block 720 at which the WAA scheduler 122 handles the non-availability of resources to execute the task (block 720). For example, the WAA scheduler 122 can generate an exception message indicative of the non-availability of resources for the requested task and cause the client interface 114 to send the exception message to the client device 104. The example instructions and/or operations 700 of FIG. 7 end.

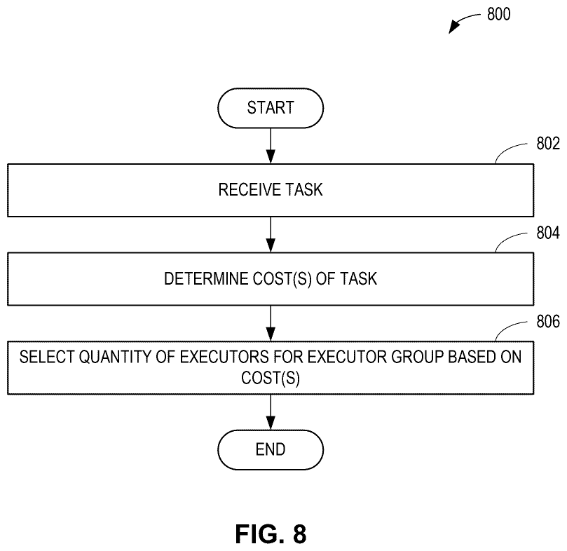

FIG. 8 is a flowchart representative of example machine-readable instructions and/or example operations 800 that may be executed, instantiated, and/or performed by example programmable circuitry to implement the WAA 102 of FIG. 1 to select a quantity of executors for an EG based on cost. The example machine-readable instructions and/or example operations 800 of FIG. 8 begin at block 802, at which the client interface 114 (FIG. 1) receives a task from the client device 104 (FIG. 1). The cost estimator 116 (FIG. 1) determines one or more costs for the task (block 804). The WAA scheduler 122 selects a quantity of executors for an EG based on the one or more cost(s) (block 806). The instructions and/or operations 800 of FIG. 8 end.

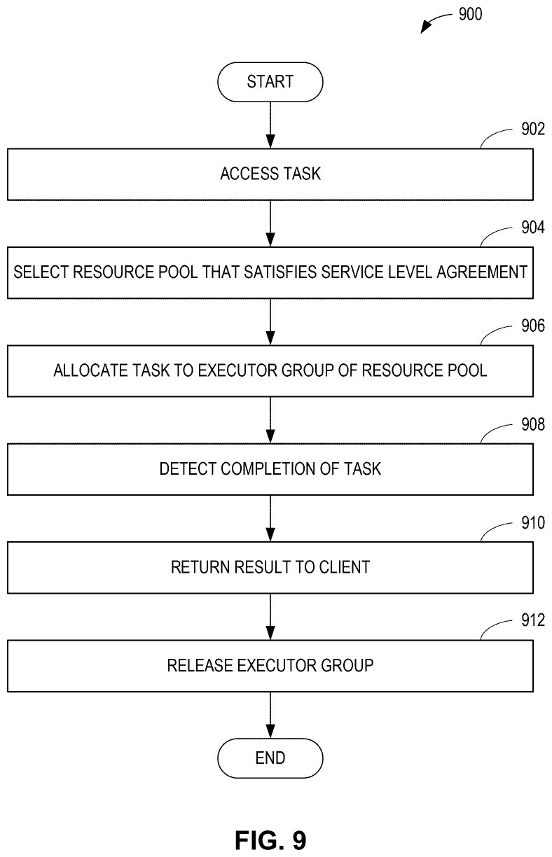

FIG. 9 is a flowchart representative of example machine-readable instructions and/or example operations 900 that may be executed, instantiated, and/or performed by example programmable circuitry to implement the WAA 102 of FIG. 1 to allocate a task and scale down an EG upon task completion. The example machine-readable instructions and/or example operations 900 of FIG. 9 begin at block 902, at which the queue interface 124 (FIG. 1) accesses a task from one of the admission queues 112 (FIG. 1). The WAA scheduler 122 selects a shared pool of compute resources 108 that satisfies an SLA of the task (block 904). The WAA scheduler 122 allocates the task to an EG corresponding to the shared pool of compute resources 108 (block 906). The WAA scheduler 122 detects completion of the task (block 908). For example, the WAA scheduler 122 can poll the EG or receive a notification from the EG indicating that the EG has completed executing the task.

The client interface 114 (FIG. 1) returns a result of the executed task to the client device 104 (block 910). For example, the result can be an output of the executed task or a notification of completion of the task. In any case, the client interface 114 can access the result from a buffer or memory location to which the allocated EG wrote the result. The client interface 114 can return the result to the client device 104 via, for example, an API response. The WAA scheduler 122 releases the EG (block 912). For example, the WAA scheduler 122 releases one or more resources of the EG based on the detection of completion of the task. For example, an idle EG is released when a release condition is satisfied. The release condition could be based on some pre-configured timeout and/or other heuristics based on an expected workload pattern (e.g., if more tasks are anticipated/expected based on a configured or historical pattern, then the WAA scheduler 122 could decide to not release an EG), SLAs (e.g., for mission-critical tasks which cannot miss an SLA requirement, EGs could be maintained and/or cached, even when idle), and/or other policies. The example instructions and/or operations 900 of FIG. 9 end.

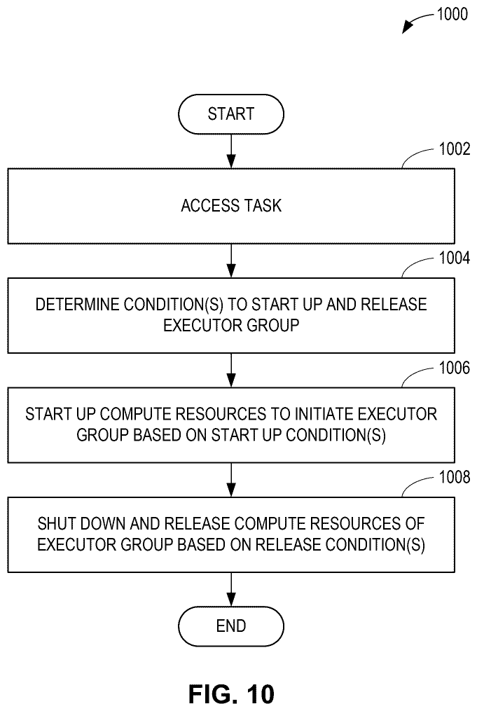

FIG. 10 is a flowchart representative of example machine-readable instructions and/or example operations 1000 that may be executed, instantiated, and/or performed by example programmable circuitry to implement the WAA 102 of FIG. 1 to scale up and scale down EGs based on one or more conditions. The example machine-readable instructions and/or example operations 1000 of FIG. 10 begin at block 1002, at which the queue interface 124 (FIG. 1) accesses a task from one of the admission queues 112 (FIG. 1). The WAA scheduler 122 determines one or more condition(s) to start up and release an EG (block 1004). For example, the one or more condition(s) may correspond to system load, workload demands, scheduled times, historical usage data, etc.

The WAA scheduler 122 starts up compute resources (e.g., executors) to initiate an EG based on one or more start-up conditions (block 1006). For example, in response to monitored conditions of a VCC environment (e.g., the VCC environment 100 (FIG. 1), the VCC environment 200 (FIG. 2), or the VCC environment 400 (FIG. 4)) satisfying start up conditions identified at block 1004, the WAA scheduler 122 can start up executors from a shared pool of compute resources 108 (FIG. 1) to instantiate an EG based on the start-up conditions.

The WAA scheduler 122 shuts down and releases compute resources (e.g., executors) of the EG based on one or more release condition(s) (block 1008). For example, in response to monitored conditions of a VCC environment (e.g., the VCC environment 100 (FIG. 1), the VCC environment 200 (FIG. 2), or the VCC environment 400 (FIG. 4)) satisfying one or more release condition(s) identified at block 1004, the WAA scheduler 122 can remove the EG by shutting down executors in the EG and releasing the executors to the shared pool of compute resources 108. Alternatively, the WAA scheduler 122 can shut down the executors to an inactive state but cache the executors in an allocated state to the EG without releasing the executors back to the shared pool of compute resources 108. In this manner, the WAA scheduler 122 can spin up the executors when a subsequent task is to be allocated to the EG without incurring the delay associated with re-allocating the executors to the EG from the shared pool of compute resources 108. The example instructions and/or operations 1000 of FIG. 10 end.

FIG. 11 is a block diagram of an example programmable circuitry platform 1100 structured to execute and/or instantiate the example machine-readable instructions and/or the example operations of FIGS. 6-10 to implement the WAA 102 of FIG. 1. The programmable circuitry platform 1100 can be, for example, a server, a personal computer, a workstation, a self-learning machine (e.g., a neural network), or any other suitable type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, XPUs, and/or microcontrollers from any desired family or manufacturer. The programmable circuitry 1112 may be implemented by one or more semiconductor based (e.g., silicon based) devices. In this example, the programmable circuitry 1112 implements the example cost estimator 116, the example planner 118, and the example WAA scheduler 122.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In the illustrated example, the interface circuitry 1120 implements the example client interface 114 and the example queue interface 124.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, a microphone, a keyboard, a button, a mouse, a touchscreen, a trackpad, and/or a trackball.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices, optical storage devices, RAID systems, and/or solid-state storage discs or devices such as flash memory devices and/or SSDs.

The machine-readable instructions 1132, which may be implemented by the machine-readable instructions of FIGS. 6-10, may be stored in the mass storage device 1128, in the volatile memory 1114, in the non-volatile memory 1116, and/or on at least one non-transitory computer readable storage medium which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 and/or components thereof may include additional and/or alternate structures to those shown and described below. The microprocessor 1200 is a semiconductor device fabricated to include transistors interconnected to implement the structures described below in one or more integrated circuits (ICs) contained in one or more packages.

The microprocessor 1200 executes machine-readable instructions of the flowcharts of FIGS. 6-10 to instantiate the circuitry of FIG. 1 as logic circuits to perform operations corresponding to those machine-readable instructions. In some such examples, the circuitry of FIG. 1 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program represented by the flowchart(s) of FIGS. 6-10 may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 6-10.

The cores 1202 may communicate by a first example bus 1204. For example, the first bus 1204 may be implemented by any suitable bus technology (e.g., an Inter-Integrated Circuit (I2C) bus, a Serial Peripheral Interface (SPI) bus, a PCI bus, a PCIe bus etc.). Data, instructions, and/or signals may be communicated (e.g., accessed, obtained, output, provided, etc.) between the cores 1202 and one or more external devices by example interface circuitry 1206. Although the cores 1202 of this example include example local cache 1220 (e.g., Level 1 (L1) cache that may be split into an L1 data cache and an L1 instruction cache), the microprocessor 1200 also includes example shared cache 1210. The shared cache 1210 is shared by the cores (e.g., Level 2 (L2 cache)) to access data and/or instructions across the cores.

Each core 1202 includes control unit circuitry 1214, arithmetic and logic (AL) circuitry (sometimes referred to as an arithmetic logic unit (ALU)) 1216, a plurality of registers 1218 (e.g., hardware registers), the local cache 1220, and a second example bus 1222. The control unit circuitry 1214 controls (e.g., coordinates) data movement within the corresponding core 1202. The AL circuitry 1216 performs one or more mathematic and/or logic operations on the data within the corresponding core 1202.

The registers 1218 store data and/or instructions such as results of operations performed by the AL circuitry 1216. The second bus 1222 may be implemented using any suitable bus technology (e.g., an I2C bus, a SPI bus, a PCI bus, or a PCIe bus, etc.).

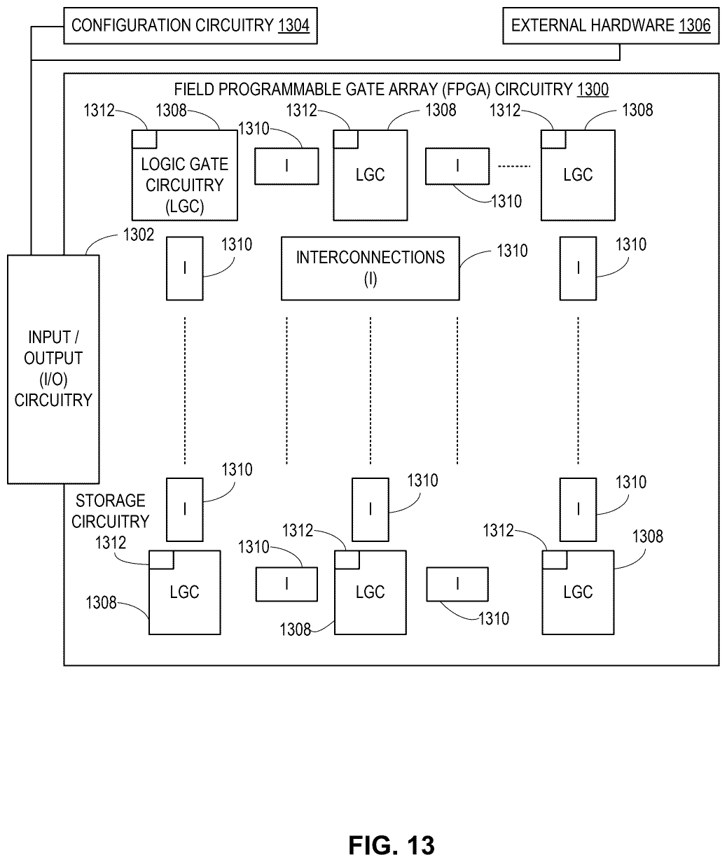

FIG. 13 is a block diagram of another example implementation of the programmable circuitry 1112 of FIG. 11. In this example, the programmable circuitry 1112 is implemented by FPGA circuitry 1300. Programmable logic circuitry of the FPGA circuitry 1300 may be programmed to create dedicated logic circuits that perform operations and/or functions represented in the flowchart(s) of FIGS. 6-10. For example, the FPGA circuitry 1300 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowchart(s) of FIGS. 6-10. After an FPGA programming process, the FPGA circuitry 1300 instantiates the operations and/or functions corresponding to the machine-readable instructions in hardware. In some examples, the FPGA circuitry 1300 can execute the operations/functions faster than they could be performed by a general-purpose microprocessor.

The FPGA circuitry 1300 of FIG. 13, includes example input/output (I/O) circuitry 1302 to obtain data from and/or output data to example configuration circuitry 1304 and/or external hardware 1306 (e.g., microprocessor circuitry, controller circuitry, memory circuitry, storage circuitry, a computer, etc.). For example, the configuration circuitry 1304 may be implemented by interface circuitry that obtains a binary file to program or configure the FPGA circuitry 1300.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to machine-readable instructions of FIGS. 6-10 and/or other desired operations.

The storage circuitry 1312 is structured to store result(s) of operations performed by corresponding logic gates. The storage circuitry 1312 may be implemented by registers or the like.

Although not shown, the example FPGA circuitry 1300 of FIG. 13 also includes example dedicated operations circuitry to implement functions without programming those functions in the logic gate circuitry 1308. The FPGA circuitry 1300 may also include general purpose programmable circuitry such as a CPU, a DSP, etc.

Although FIGS. 12 and 13 illustrate two example implementations of the programmable circuitry 1112 of FIG. 11, many other approaches are contemplated. For example, a hybrid circuitry example may include one or more cores 1202 of FIG. 12 that execute(s) a first portion of the machine-readable instructions represented by the flowchart(s) of FIGS. 6-10 to perform first operation(s)/function(s), and/or include the FPGA circuitry 1300 of FIG. 13 configured and/or structured to perform second operation(s)/function(s) corresponding to a second portion of the machine-readable instructions represented by the flowcharts of FIG. 6-10, and/or include an ASIC configured and/or structured to perform third operation(s)/function(s) corresponding to a third portion of the machine-readable instructions represented by the flowcharts of FIGS. 6-10.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 1112 of FIG. 11 may be in one or more packages. For example, the microprocessor 1200 of FIG. 12 and/or the FPGA circuitry 1300 of FIG. 13 may be in one or more packages.

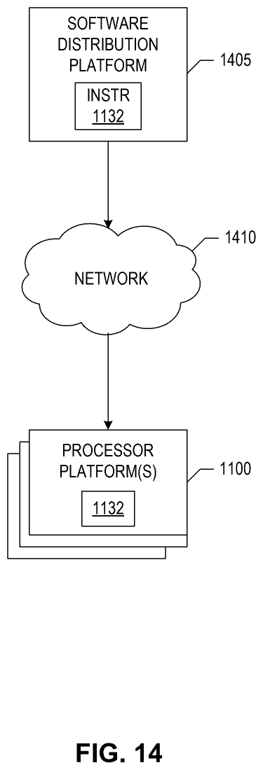

A block diagram illustrating an example software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. In the illustrated example, the software distribution platform 1405 includes one or more servers and one or more storage devices. The storage devices store the machine-readable instructions 1132, which may correspond to the example machine-readable instructions of FIGS. 6-10, as described above. The one or more servers of the example software distribution platform 1405 are in communication with an example network 1410, which may correspond to any one or more of the Internet and/or any of the example networks described above. The servers enable downloading the machine-readable instructions 1132 from the software distribution platform 1405. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include any circuitry that can be programmed or configured to perform different operations and that includes one or more semiconductor-based logic devices (e.g., electrical hardware implemented by one or more transistors. Programmable circuitry may be: (i) one or more special purpose electrical circuits (e.g., an ASIC) and/or (ii) one or more general purpose semiconductor-based electrical circuits programmable with instructions. Examples of programmable circuitry include programmable microprocessors such as CPUs, FPGAs, GPUs, DSPs, XPUs, Network Processing Units (NPUs), and/or integrated circuits such as ASICs. For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing tasks to whichever one(s) of the multiple types of programmable circuitry is/are suited and available to perform the computing tasks.

From the foregoing, it will be appreciated that example systems, apparatus, articles of manufacture, and methods have been disclosed that autoscale executor groups based on needs of workloads. Disclosed systems, apparatus, articles of manufacture, and methods improve the efficiency of using a computing device by scaling up or scaling down resource capacity by dynamically instantiating executor groups, shutting down and releasing executor groups, adding executors in provisioned executor groups, or removing executors from executor groups based on one or more conditions associated with task execution. In this manner, examples disclosed herein can dynamically scale up resources based on workload conditions when resources are needed and dynamically scale down resources when workload conditions indicate that such resources are not needed. This increases compute efficiencies by allocating and using specific numbers of resources needed to execute tasks while releasing resources that are not needed. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to autoscale a virtual compute cluster based on resource demands of tasks, comprising:
interface circuitry;
machine-readable instructions; and
at least one processor circuit to be programmed by the machine-readable instructions to:
select a first quantity of executors for a first executor group in the virtual compute cluster;
select a second quantity of executors for a second executor group in the virtual compute cluster, the first quantity of executors different from the second quantity of executors;
in response to a first task, instantiate the first executor group in the virtual compute cluster based on the first quantity of executors satisfying a first resource demand of the first task; and
in response to a second task, instantiate the second executor group in the virtual compute cluster based on the second quantity of executors satisfying a second resource demand of the second task.

2. The apparatus of claim 1, wherein the first quantity of executors is determined dynamically upon receipt of the first task based on characteristics of the first task.

3. The apparatus of claim 1, wherein one or more of the at least one processor circuit is to release one or more resources of the first executor group after processing of the first task is complete.

4. The apparatus of claim 1, wherein the first executor group includes a plurality of compute resources, wherein one or more of the at least one processor circuit is to:
start up the compute resources to instantiate the first executor group based on a first system load and a first workload demand of the virtual compute cluster, or
shut down the compute resources of the first executor group based on a second system load and a second workload demand of the virtual compute cluster.

5. The apparatus of claim 1, wherein one or more of the at least one processor circuit is to enqueue the first task in a first admission queue corresponding to the first executor group, and enqueue the second task in a second admission queue corresponding to the second executor group.

6. The apparatus of claim 5, wherein one or more of the at least one processor circuit is to promote a third task from a third admission queue corresponding to a third executor group to the first admission queue corresponding to the first executor group based on a service level agreement of the third task.

7. The apparatus of claim 1, wherein one or more of the at least one processor circuit is to:
based on a first time specified in a schedule, instantiate a third executor group in the virtual compute cluster; and
based on a second time specified in the schedule, release the third executor group.

8. The apparatus of claim 1, wherein one or more of the at least one processor circuit is to:
based on historical usage data, instantiate a third executor group in the virtual compute cluster; and
based on the historical usage data, release the third executor group.

9. At least one non-transitory machine-readable medium comprising machine-readable instructions to cause at least one processor circuit to at least:
select a first quantity of executors for a first executor group in a virtual compute cluster;
select a second quantity of executors for a second executor group in the virtual compute cluster, the first quantity of executors different from the second quantity of executors;
in response to a first task, instantiate the first executor group in the virtual compute cluster based on the first quantity of executors satisfying a first resource demand of the first task; and
in response to a second task, instantiate the second executor group in the virtual compute cluster based on the second quantity of executors satisfying a second resource demand of the second task.

10. The at least one non-transitory machine-readable medium of claim 9, wherein the first quantity of executors is determined dynamically upon receipt of the first task based on characteristics of the first task.

11. The at least one non-transitory machine-readable medium of claim 9, wherein the machine-readable instructions are to cause one or more of the at least one processor circuit to release one or more resources of the first executor group after processing of the first task is complete.

12. The at least one non-transitory machine-readable medium of claim 9, wherein the first executor group includes a plurality of compute resources, wherein the machine-readable instructions are to cause one or more of the at least one processor circuit to:
start up the compute resources to instantiate the first executor group based on a first system load and a first workload demand of the virtual compute cluster, or
shut down the compute resources of the first executor group based on a second system load and a second workload demand of the virtual compute cluster.

13. The at least one non-transitory machine-readable medium of claim 9, wherein the machine-readable instructions are to cause one or more of the at least one processor circuit to enqueue the first task in a first admission queue corresponding to the first executor group, and enqueue the second task in a second admission queue corresponding to the second executor group.

14. The at least one non-transitory machine-readable medium of claim 13, wherein the machine-readable instructions are to cause one or more of the at least one processor circuit to promote a third task from a third admission queue corresponding to a third executor group to the first admission queue corresponding to the first executor group based on a service level agreement of the third task.

15. The at least one non-transitory machine-readable medium of claim 9, wherein the machine-readable instructions are to cause one or more of the at least one processor circuit to:
based on a first time specified in a schedule, instantiate a third executor group in the virtual compute cluster; and
based on a second time specified in the schedule, release the third executor group.

16. The at least one non-transitory machine-readable medium of claim 9, wherein the machine-readable instructions are to cause one or more of the at least one processor circuit to:
based on historical usage data, instantiate a third executor group in the virtual compute cluster; and
based on the historical usage data, release the third executor group.

17. A method comprising:
selecting a first quantity of executors for a first executor group in a virtual compute cluster;
selecting a second quantity of executors for a second executor group in the virtual compute cluster, the first quantity of executors different from the second quantity of executors;
in response to a first task, instantiating, by at least one processor circuit programmed by at least one instruction, the first executor group in the virtual compute cluster based on the first quantity of executors satisfying a first resource demand of the first task; and
in response to a second task, instantiating, by one or more of the at least one processor circuit, the second executor group in the virtual compute cluster based on the second quantity of executors satisfying a second resource demand of the second task.

18. The method of claim 17, wherein the first quantity of executors is determined dynamically upon receipt of the first task based on characteristics of the first task.

19. The method of claim 17, including releasing one or more resources of the first executor group after processing of the first task is complete.

20. The method of claim 17, wherein the first executor group includes a plurality of compute resources, the method including:
starting up the compute resources to instantiate the first executor group based on a first system load and a first workload demand of the virtual compute cluster, or
shutting down the compute resources of the first executor group based on a second system load and a second workload demand of the virtual compute cluster.

21. The method of claim 17, including enqueuing the first task in a first admission queue corresponding to the first executor group, and enqueueing the second task in a second admission queue corresponding to the second executor group.

22. The method of claim 21, including promoting a third task from a third admission queue corresponding to a third executor group to the first admission queue corresponding to the first executor group based on a service level agreement of the third task.

23. The method of claim 17, including:
based on a first time specified in a schedule, instantiating a third executor group in the virtual compute cluster; and
based on a second time specified in the schedule, releasing the third executor group.

24. The method of claim 17, including:
based on historical usage data, instantiating a third executor group in the virtual compute cluster; and
based on the historical usage data, releasing the third executor group.
